(19) United States
(12) Patent Application Publication
(10) Pub. No.: US 2013/0259980 A1
(43) Pub. Date: Oct. 3, 2013

(54) Method For Forming A Flavored Confectionery Treat

(71) Applicant: Russell L. Caldwell, Garden Prairie, IL (US)

(72) Inventor: Russell L. Caldwell, Garden Prairie, IL (US)

(73) Assignee: CCSI International, Garden Prairie, IL (US)

(21) Appl. No.: 13/437,495

(22) Filed: Apr. 2, 2012

(51) Int. Cl. A23G 9/48; A23G 3/54

(52) U.S. Cl. 426/94; 426/660; 426/101

(57) ABSTRACT

A method and apparatus is provided for adding a uniform amount of a confectionery flavor to an ice cream based confectionery treat. A flavor rod is either formed from compressed pieces of a confectionery flavor formed into a rod or from adhering a confectionery flavor to a rod shaped food item. The flavor rod is then placed into an ice cream receptacle such that the flavor rod is orthogonally aligned with a plane formed by a threshold of the receptacle. Ice cream is then dispensed around the flavor rod to form an ice cream based confectionery treat with a confectionery flavor disbursed through the interior of the ice cream. The flavor rod provides both a guide for forming the treat and support for the ice cream such that the ice cream is vertically straight and does not fall from the receptacle.

### FIELD OF THE INVENTION

This invention generally relates to confectionery treats, and more particularly to methods and an apparatus to add support and confectionery flavor to a soft serve ice cream based confectionery treat.

### BACKGROUND OF THE INVENTION

Ice cream is a common confectionery treat served in many restaurants throughout the world. Ice cream comes in either a form served in scoops or in a soft-serve form. Further, the ice cream may be served in many types of receptacles such as a bowl or a cone.

Additionally, ice cream may be made with different flavors such as chocolate, vanilla, or various other flavors. Usually flavored ice cream is made with the flavor mixed into the ice cream itself prior to being served such that the flavor is uniform throughout the ice cream. Often it is desirable to add another confectionery flavor in the form of a sprinkled topping to the ice cream. Typically, when adding a topping to ice cream, a confectionery flavor is sprinkled on top of the ice cream after the ice cream is placed into the bowl or cone. The confectionery flavor is usually ground up or crushed candy or cookies, such as OREO®, BUTTERFINGER®, TWIX®, SNICKERS®, HEATH®, brownie, dried fruit, granola, or any other type of fruit, nut, candy or cookie.

Because the sprinkled topping is added on top of the ice cream it is only distributed on a top layer and not internal to the ice cream itself. This presents a problem because the additional flavor is only present in just the first few bites that the consumer has of the confectionery treat. After the topping sprinkled on top of the ice cream is consumed, the remaining ice cream will only have its original flavor.

Furthermore, by adding the sprinkled topping to the ice cream each time a confectionery treat is made it becomes difficult to guarantee that the exact same amount of sprinkled topping is used for each treat. This creates some confectionery treats with too little or too much sprinkled topping added. If too much topping is added, the flavor of the topping may overpower the overall flavor of the confectionery treat and create an undesirable flavor for the consumer while also wasting sprinkled topping that could be used for other treats. If too little topping is used, the desired flavor of the topping will underwhelm the consumer and create an undesirable experience.

Another problem with merely sprinkling the topping onto the ice cream is that excess topping may fall outside of the receptacle thereby creating a mess that takes time to clean. Any additional time required to clean up after creation of the treat is undesirable. Further, sometimes a machine that drops a sprinkled topping onto ice cream is used to add sprinkled topping to a confectionery treat. Typically, the individual making the treat will tilt the ice cream based confectionery treat in order to achieve a uniform covering of the sprinkled topping. The process of tilting the ice cream based treat often results in the ice cream falling from the ice cream receptacle thereby destroying the treat and creating a mess.

Yet another problem with sprinkling a topping on the ice cream is that the topping provides no support for the ice cream. A prior art ice cream cone 10 is illustrated in FIG. 12. Typically, as ice cream warms up from being exposed to a warmer environment where ice cream is typically consumed, the ice cream will begin to melt. As the ice cream melts it loses structural integrity. This causes the ice cream to slump over, as illustrated in FIG. 12, or even to fall from the cone or bowl in which the ice cream was served.

Another problem with sprinkling a topping on the ice cream is that it does not provide a guide for forming the treat. An important aspect of any confectionery treat is that it provides an appealing appearance. In the case of an ice cream based confectionery treat, especially a soft-serve ice cream based treat, it is desirable for the treat to be vertically straight and symmetric about a center axis, or in other words for the ice cream to not lean to one side or the other. Often, when forming an ice cream based confectionery treat, the clerk will not be able to form the ice cream in a straight aesthetically pleasing way. The ice cream may be gathered to one side of the receptacle or crooked, which creates a less desirable experience for the consumer.

Therefore, it would be advantageous to provide a confectionery flavor that is easy to add to the ice cream, adds flavor to the ice cream, provides a guide while forming the ice cream, and provides structural support while forming the ice cream based treat, and as the ice cream melts. An embodiment of the invention provides such a confectionery flavor that both adds flavor and provides support to the ice cream. These and other advantages of the invention, as well as additional inventive features, will be apparent from the description of the invention provided herein.

### BRIEF SUMMARY OF THE INVENTION

In view of the above, embodiments of the present invention provide new and improved ice cream based confectionery treats that overcome problems existing in the art. More particularly, embodiments of the present invention provide new and improved formation of ice cream based confectionery treats that overcome problems existing in the art. Still more particularly, embodiments of the present invention provide new and improved ice cream based treats that have a confectionery flavor dispersed through a vertical length of the treat, minimize wasted confectionery flavor, provide a guide for forming an aesthetically pleasing treat, and include a support structure for the ice cream.

In one embodiment a flavor rod is added to an ice cream based confectionery treat. The flavor rod is inserted lengthwise into an ice cream receptacle, which is typically an ice cream cone or bowl. Soft-serve ice cream is then dispensed into the ice cream receptacle and around the flavor rod thereby forming the ice cream around the flavor rod.

By inserting the flavor rod into the ice cream receptacle, the individual creating the confectionery treat will have a guide to form the ice cream. Having a guide for forming the ice cream will help to create an aesthetically pleasing appearance to the treat.

Further, the flavor rod provides support for the ice cream based confectionery treat. The ice cream is formed around the flavor rod, and as such the flavor rod will in turn support the ice cream such that it will not lean or slump as the treat is being handled or as the ice cream melts.

In another embodiment, the flavor rod is created prior to being inserted into the ice cream receptacle such that a uniform amount of confectionery flavor is used for each flavor rod. Further, because the flavor rod extends lengthwise through the ice cream, the flavor is distributed from the top to the bottom of the ice cream receptacle.

Other aspects, objectives and advantages of the invention will become more apparent from the following detailed description when taken in conjunction with the accompanying drawings.

### BRIEF DESCRIPTION OF THE DRAWINGS

The accompanying drawings incorporated in and forming a part of the specification illustrate several aspects of the present invention and, together with the description, serve to explain the principles of the invention. In the drawings:

FIG. 1 is a flavor rod in accordance with embodiments of the present invention;

FIG. 2 is an isometric view of the flavor rod of FIG. 1 inside an ice cream cone, in accordance with an embodiment of the present invention;

FIG. 3 is an isometric view of a flavor rod of FIG. 1 inside a bowl, in accordance with an embodiment of the present invention;

FIG. 4 is an isometric view of the flavor rod of FIG. 1 inside an ice cream cone including a support structure for the flavor rod, in accordance with an embodiment of the present invention;

FIG. 5 is an isometric view of the flavor rod of FIG. 1 inside a bowl including a support structure for the flavor rod, in accordance with an embodiment of the present invention;

FIG. 6 is an isometric view of the flavor rod and cone of FIG. 2 with soft-serve ice cream being formed around the flavor rod, in accordance with an embodiment of the present invention;

FIG. 7 is an isometric view of the of the flavor rod and bowl of FIG. 3 with soft-serve ice cream being formed around the flavor rod, in accordance with an embodiment of the present invention;

FIG. 8 is an isometric view of the flavor rod and cone of FIG. 6 with soft-serve ice cream in the cone and fully formed around the flavor rod, in accordance with an embodiment of the present invention;

FIG. 9 is an isometric view of the flavor rod and bowl of FIG. 7 with soft-serve ice cream in the bowl and fully formed around the flavor rod, in accordance with an embodiment of the present invention;

FIG. 10 is an isometric view of the flavor rod of FIG. 1 being inserted into ice cream inside an ice-cream cone, in accordance with an embodiment of the present invention;

FIG. 11 is an isometric view of the flavor rod of FIG. 1 being inserted into ice cream inside a bowl, in accordance with an embodiment of the present invention; and

FIG. 12 is a prior art illustration of an ice cream cone with ice cream slumped over the side of the cone.

While the invention will be described in connection with certain preferred embodiments, there is no intent to limit it to those embodiments. On the contrary, the intent is to cover all alternatives, modifications and equivalents as included within the spirit and scope of the invention as defined by the appended claims.

### DETAILED DESCRIPTION OF THE INVENTION

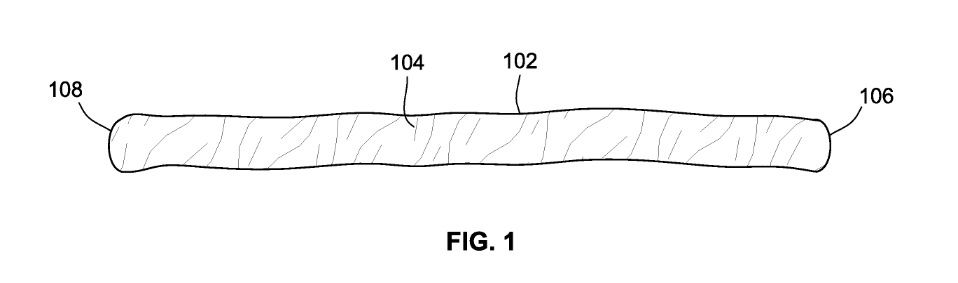

FIG. 1 illustrates a flavor rod 102. Flavor rod 102 is a rigid rod that is inserted into an ice cream receptacle such as a cone or bowl in order to both act as a guide for forming an ice cream based confectionery treat and provide support for the ice cream. As an aside, ice cream, as used herein, includes frozen custard, frozen yogurt, sorbet, gelato, and any other frozen dairy or non-dairy based frozen confectionery treats. Further, while the embodiments of the invention discussed below generally pertain to frozen confectionery treats, non-frozen confectionery treats such as gelatin, pudding, cake, or any other confectionery treat that may benefit from the flavor rod 102 are also contemplated.

The flavor rod 102 is a rigid rod made from a variety of confectioneries, such as OREO®, BUTTERFINGER®, TWIX®, SNICKERS®, HEATH®, brownie, dried fruit, granola, or any other type of fruit, nut, candy or cookie chosen to provide a certain flavor 104. Typically, the flavor 104 is formed into a long cylindrical flavor rod 102 and compressed together such that flavor rod 102 is a rigid structure. In other embodiments the flavor 104 is coated around a long cylindrical cookie, pretzel, or any rigid edible structure to form the flavor rod 102. In even other embodiments, the flavor rod 102 is not cylindrical, and could take the form of any three-dimensional-elongated-polygon shape, such as an elongated-three-dimensional triangle or square.

In another embodiment, the flavor rod 102 is formed by a single confectionery flavor 104 such that only one additional flavor 104 is added to the ice cream. While embodiments of the invention described herein detail only one or two flavors, a flavor rod 102 with more than one or even two flavors 104 is contemplated. Also, it is contemplated that the additional flavors can be added to and mixed with flavor 104 or can be arranged in a stratified manner along the flavor rod 102. By stratifying the flavors a different flavor can be experienced by the consumer while consuming different portions of the confectionery treat. In this manner, multiple flavors will be infused into a single flavor rod 102 to create more complex flavors, such as fruits and nuts, and sweet and salty.

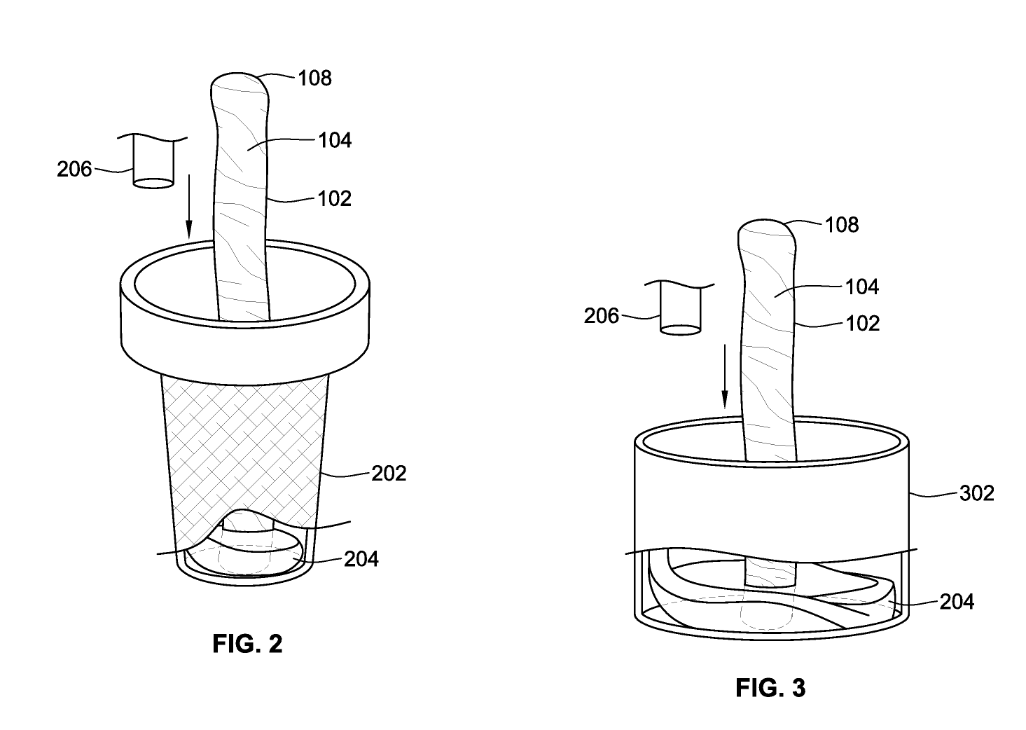

The flavor rod 102 is formed with two ends, a first end 106 and a second end 108. The first end 106 is typically the initial end inserted into a cone or bowl such that the second end 108 extends out of the threshold of the cone or bowl, as illustrated in FIGS. 2-9. Further, the flavor rod 102 can be created in a variety of lengths and thicknesses such that a uniform amount of confectionery is used in each flavor rod 102.

FIGS. 2 and 3 illustrate the insertion of a flavor rod 102 into a cone 202 and a bowl 302, respectively. Initially, a small amount of soft serve ice cream 204 is dispensed from a soft serve ice cream dispenser 206 into the bottom of the cone 202 or bowl 302 prior to inserting the flavor rod 102. By dispensing the ice cream 204 into the cone 202 or bowl 302 first, the flavor rod 102 can be inserted into the small amount of ice cream 204 such that the flavor rod 102 stands upright on its own without assistance from the individual creating the ice cream based confectionery treat. Typically, the flavor rod 102 is inserted into the cone 202 or bowl 302 such that the second end 108 extends substantially orthogonal to a plane formed by the threshold 206 of the cone 202 or a threshold 306 of the bowl 302.

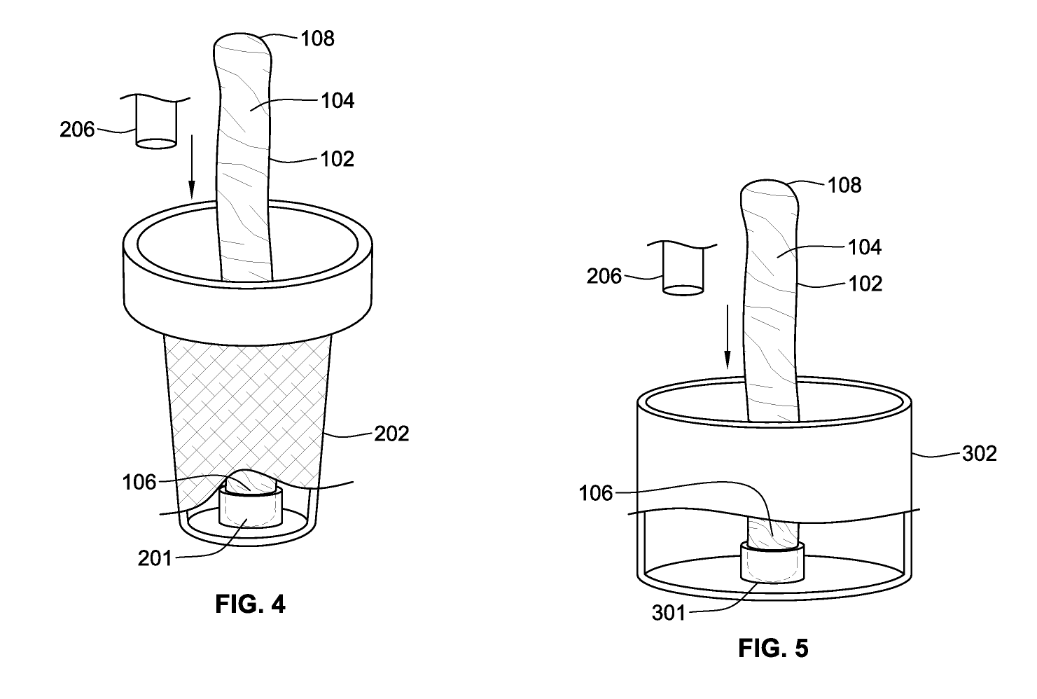

In other embodiments, the flavor rod 102 is formed along with the cone 202 such that the first end 106 of the flavor rod 102 is attached to the base of the cone 202. In even a further embodiment, the user merely holds the flavor rod 102 upright while creating the ice cream based confectionery treat without placing an initial amount of ice cream in the bottom of the cone 202 or bowl 302. And in an even further embodiment, as respectively illustrated in FIGS. 4 and 5, a cone 202 or bowl 302 is formed with a holding structure 201 for the cone 202 and a holding structure 301 for the bowl 302. The holding structure 201 and holding structure 301 are formed to receive the first end 106 of the flavor rod 102 such that the flavor rod 102 is held in an upright position while ice cream is dispensed into the ice cream receptacle.

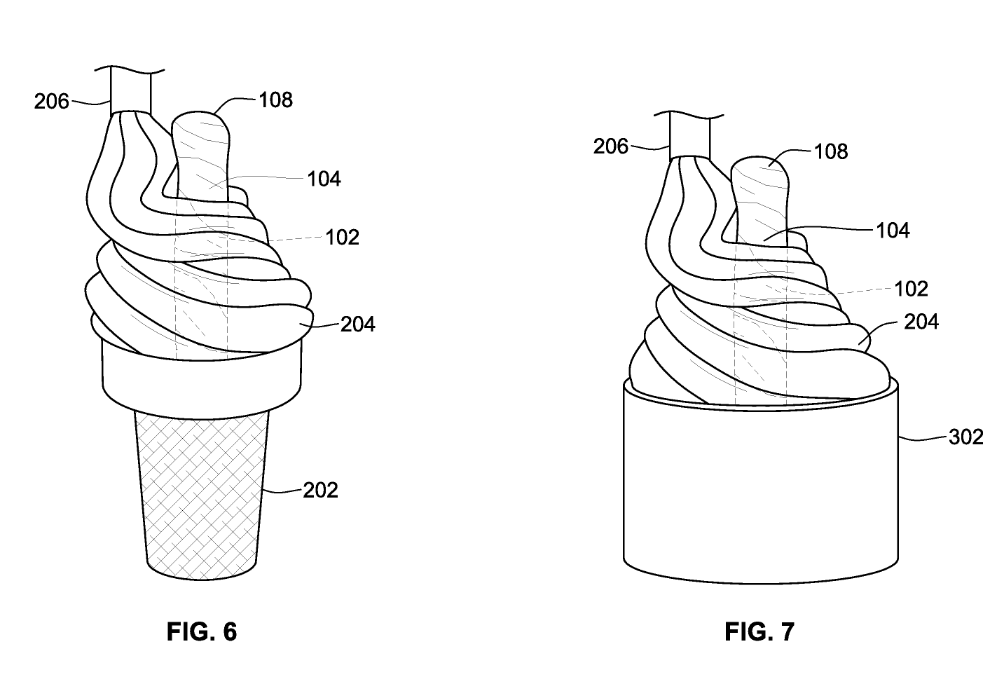

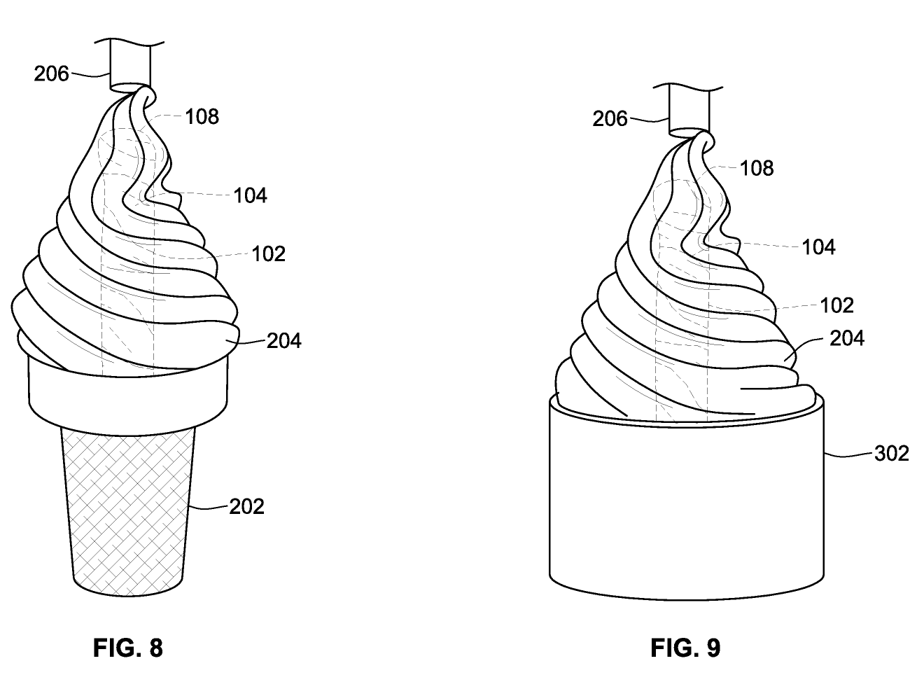

FIGS. 6 and 7 illustrate soft-serve ice cream 204, from the soft-serve ice cream dispenser 206, formed around the flavor rod 102 and in the cone 202 or bowl 302. In this particular embodiment of the invention, the flavor rod 102 has been inserted into the cone 202 or bowl 302 containing a small amount of ice cream 204 such that the flavor rod stands upright substantially in the middle of the opening of the cone 202 or bowl 302, as illustrated in FIGS. 2-3. Soft serve ice cream 204 is then dispensed around the flavor rod 102 such that the ice cream 204 is formed around the flavor rod 102. Once the cone 202 or bowl 302 is filled with the desired amount of ice cream 204, a consumer may begin to eat the ice cream 204 and rod 102. FIGS. 8-9 illustrate the finished confectionery treat with the ice cream 204 formed around the full length of the flavor rod 102.

Preferably, the flavor rod 102 extends beyond the threshold of the cone 202 or bowl 302 such that ice cream 204 may be formed around the rod 102 above the threshold. Typically, the ice cream 204 will be formed over the entire length of the rod 102 and even beyond the end 108 of the rod 102 (as shown in FIGS. 8-9). However, it is contemplated that ice cream 204 may only be formed partially along the rod 102 such that the ice cream 204 does not cover the end 108. In either configuration, because the rod 102 extends through the ice cream 204, the consumer receives the flavor of the rod 102 through the course of eating the confectionery treat, as opposed to just receiving the flavor 104 from the first few bites when the flavor 104 is merely sprinkled on the top of the ice cream 204.

Additionally, the flavor rod 102 provides structure to the ice cream 204 because the ice cream 204 is formed around the flavor rod 102. By providing structure, the flavor rod 102 will keep the ice cream 204 from slumping or dropping from the cone 202 or bowl 302 both as the ice cream 204 is formed around the flavor rod 102 and as the ice cream 204 melts. Further, by inserting the flavor rod 102 prior to the ice cream 204, the individual creating the ice cream based confectionery treat will have a guide such that the ice cream 204 is vertically straight, thereby creating a desirable appearance to the treat.

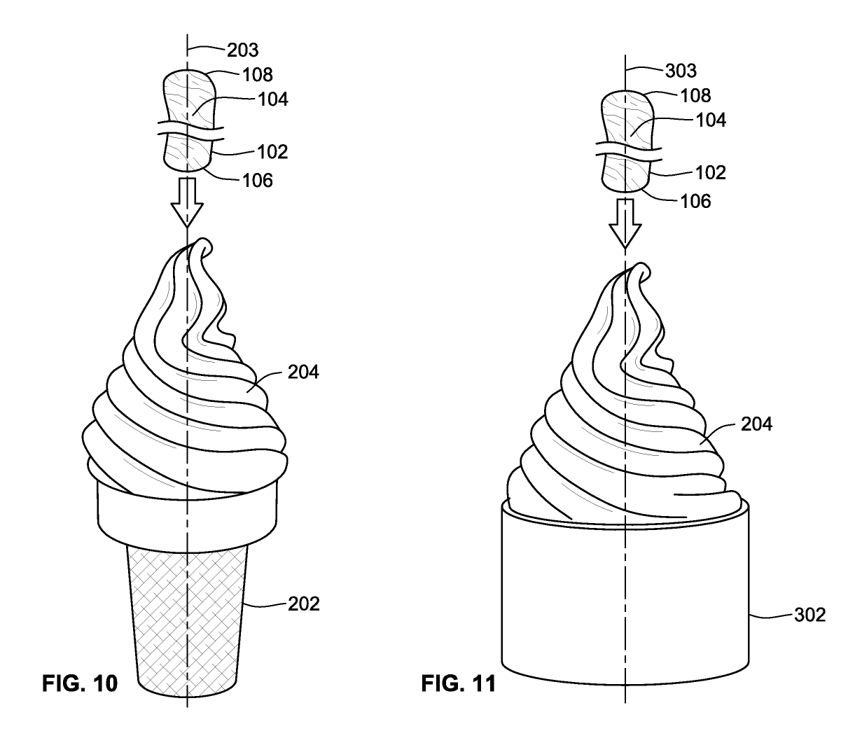

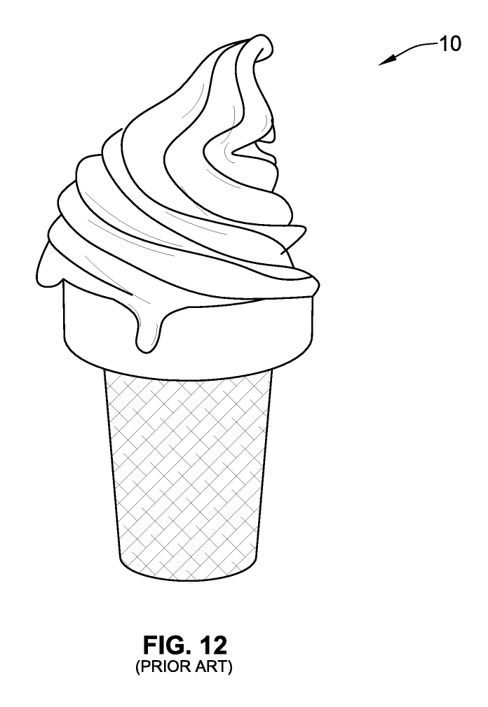

In another embodiment of the present invention, the flavor rod 102 is inserted into the cone 202 or bowl 302 after the ice cream is dispensed into the cone 202 or bowl 302. FIG. 10 illustrates inserting the flavor rod 102 into ice cream 204 along a center axis 203, and FIG. 11 illustrates inserting the flavor rod 102 into ice cream 204 along a center axis 303. The ice cream 204 is illustrated as soft-serve ice cream but this embodiment of the invention contemplates using scoops of ice cream as well. The first end 106 of the flavor rod 102 is inserted first. The flavor rod 102 is pressed into the ice cream until either the first end 106 meets the bottom of the cone 202 or the bowl 302, or until the rod 102 is substantially inside the ice cream 204 and past the threshold of the cone 202 or bowl 302. By inserting the flavor rod 102 down the center axis 203 of the cone 202 or the center axis 303 of bowl 302 and at least past the threshold of the cone 202 or bowl 302, the flavor rod 102 will provide support to the ice cream 203 thereby preventing the ice cream 204 from slumping or falling over the edge of the cone 202 or bowl 302. Further, the rigid structure of the rod 102 provides support for the ice cream 204 as it begins to melt.

All references, including publications, patent applications, and patents cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A method of building an ice cream based confectionery treat, comprising the steps of:
inserting a first end of a flavor rod into an ice cream receptacle such that the flavor rod is aligned substantially orthogonal to a plane formed by a threshold of the ice cream receptacle; and
forming ice cream around the flavor rod and into the ice cream receptacle.

2. The method of claim 1, further comprising the step of dispensing an initial amount of ice cream onto a bottom surface of the ice cream receptacle prior to inserting the first end of the flavor rod into the ice cream receptacle.

3. The method of claim 1, wherein the step of inserting a first end of the flavor rod into an ice cream receptacle provides structural support to the ice cream.

4. The method of claim 1, wherein the step of forming ice cream around the flavor rod further comprises dispensing soft-serve ice cream from a soft-serve ice cream dispenser.

5. The method of claim 1, wherein the step of forming ice cream comprises the step of dispensing ice cream around an entire length of the flavor rod.

6. The method of claim 1, wherein the step of forming ice cream comprises the step of dispensing ice cream around less than an entire length of the flavor rod.

7. The method of claim 1, wherein the step of forming ice cream comprises the step of dispensing ice cream around more than an entire length of the flavor rod.

8. An ice cream based confectionery treat, comprising:
an at least one confectionery flavor formed into a flavor rod;
a first end of the flavor rod inserted into an ice cream receptacle such that the flavor rod is substantially orthogonal to a plane formed by a threshold of the ice cream receptacle;
a second end of the flavor rod extending from the threshold of the ice cream receptacle; and
an ice cream dispensed into the ice cream receptacle and formed around the flavor rod.

9. The ice cream based confectionery treat of claim 8, wherein the flavor rod provides structural support to the ice cream.

10. The ice cream based confectionery treat of claim 8, wherein the ice cream is soft serve ice cream.

11. The ice cream based confectionery treat of claim 8, wherein the flavor rod provides at least one confectionery flavor internal to the ice cream.

12. The ice cream based confectionery treat of claim 8, wherein the flavor rod includes a second confectionery flavor combined with the at least one confectionery flavor.

13. The ice cream based confectionery treat of claim 8, wherein the flavor rod is formed by adhering the at least one confectionery flavor to a pretzel rod.

14. The ice cream based confectionery treat of claim 8, wherein the flavor rod is formed by adhering the at least one confectionery flavor to a cookie rod.

15. The ice cream based confectionery treat of claim 8, wherein the ice cream receptacle is an ice cream cone.

16. The ice cream based confectionery treat of claim 15, wherein the ice cream cone includes a support structure at a bottom of the cone to receive the first end of the flavor rod.

17. The ice cream based confectionery treat of claim 8, wherein the ice cream receptacle is a bowl.

18. The ice cream based confectionery treat of claim 17, wherein the bowl includes a support structure at the bottom of the bowl to receive the first end of the flavor rod.

19. A flavor rod for providing support to an ice cream based confectionery treat, comprising:
an at least one confectionery flavor formed into a rod;
a first end of the rod; and
a second end of the rod.

20. The flavor rod of claim 19, wherein the at least one confectionery flavor formed into a rod includes a first confectionery flavor and a second confectionery flavor.

21. The flavor rod of claim 20, wherein the rod comprises a first portion and a second portion and the first confectionery flavor is formed into the first portion of the rod and the second confectionery flavor is formed into a second portion of the rod.

22. The flavor rod of claim 19, wherein the rod is formed by adhering the at least one confectionery flavor to a pretzel rod.

23. The flavor rod of claim 19, wherein the rod is formed by adhering the at least one confectionery flavor to a cookie rod.

24. The flavor rod of claim 19, wherein the rod is cylindrical in shape.
